(19) United States
(12) Patent Application Publication
(10) Pub. No.: US 2010/0118545 A1
(43) Pub. Date: May 13, 2010

(54) LIGHTING STRUCTURE

(75) Inventors: Willem Lubertus Ijzerman, Eindhoven (NL); Michel Cornelis Josephus Marie Vissenberg, Eindhoven (NL); Hugo Johan Cornelissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/594,202

(22) PCT Filed: Mar. 31, 2008
(86) PCT No.: PCT/IB2008/051201

§ 371 Date: Oct. 1, 2009

(30) Foreign Application Priority Data
Apr. 6, 2007 (EP) 07105817.6

(51) Int. Cl. F21V 7/00

(52) U.S. Cl. 362/296.01

(57) ABSTRACT

A lighting structure comprises a light generation assembly comprising a light source for generating light. In order to meet desired lighting requirements, the lighting structure further comprises a substantially plate-shaped light guiding structure. The light guiding structure is provided with a light assembly recess and a light emission structure. The light generation assembly is arranged in the light assembly recess of the light guiding structure such that light emitted by the light generation assembly enters and propagates in the light guiding structure. The light emission structure is arranged for emitting the propagating light from the light guiding structure.

### FIELD OF THE INVENTION

The present invention relates to a lighting structure and in particular to a flat and thin lighting structure.

### BACKGROUND OF THE INVENTION

In a known lighting structure such as a luminary, a fluorescent lamp such as a tube light (TL) is used to provide light. In general a lighting structure should meet a number of requirements, if the lighting structure is to be used in an office or other professional environment. For example, a first requirement may be that the lighting structure and the light source have a sufficiently long lifetime. Replacing light sources adds costs, not only the costs for the light source itself, but also costs for a person required to replace the light source. Further, as a second requirement, the light source and the luminary should not attract dust and other dirt. Dust and dirt that is collected on the light source and/or luminary blocks the light and as a result the light output would decrease over time. Consequently, the light source and luminary would require cleaning once in a while, again adding to cost of ownership. As a third requirement, a light luminary in a professional environment should satisfy an anti glare requirement. The anti-glare requirement is satisfied, if a unified glare ratio is sufficiently small (see: M. Rea, “Lighting Handbook”, ninth edition, IES). In short, the anti-glare requirement means that the lighting luminary should not show bright lighting spots; in particular no bright spots should be visible when the light source is viewed under an oblique angle. In practice, there is no light output under angles above e.g. about 60°. A fluorescent lamp such as the above-mentioned TL does not meet all the above-presented requirements.

As a further drawback of the known TL lighting, a TL luminary is relatively thick (a diameter is usually larger than about 5 cm) and the TL luminary is not suitable for outputting light having a saturated color.

### OBJECT OF THE INVENTION

It is an object of the present invention to provide a lighting structure that fulfills at least one of the above requirements.

### SUMMARY OF THE INVENTION

The above object is achieved in a lighting structure according to claim 1.

In the lighting structure according to the present invention, a light generation assembly comprising a light source for generating light and the light generation assembly is arranged in a light assembly recess of a light guiding structure. The light guiding structure is a substantially plate-shaped structure and is provided with the light assembly recess and a light emission structure. Light emitted by the light generation assembly arranged in the light assembly recess propagates into the light guiding structure. The light emission structure is arranged for emitting light from the light guiding structure. Thus, light is generated by the light generation assembly and transferred into the light guiding structure. The light propagating in the light guiding structure may arrive at the light emission structure. The light emission structure is then such that at least a part of the light is emitted from the light guiding structure.

In an embodiment, the light source comprised in the light generation assembly may be a light emitting diode (LED). A LED is relatively small and enables a thin lighting structure.

The light guiding structure may be a solid, optically transmissive medium, but may as well be a fluidum contained in a suitable, optically transmissive container.

In an embodiment, the light generation assembly is configured for generating a light beam having a predetermined angular spread. In general, the light spread of most light sources, e.g. a LED, is spherically shaped. In order to control a light output of the lighting structure, the light spread of the light generation assembly may be shaped to have a predetermined angular spread.

In an embodiment, the light generation assembly may comprise a collimator, in particular a compound parabolic collector, for generating the light beam having a predetermined angular spread from light emitted by the light source.

In an embodiment, the light generation assembly comprises a controllable optical element for controlling the light beam having a predetermined angular spread, in particular for controlling its angular spread. The controllable optical element may in particular be a PDLC diffuser for electrically adjusting the angular spread.

In an embodiment, the light guiding structure comprises a first main surface and a second main surface being opposite to the first main surface. In this embodiment, the light emission structure comprises a reflection recess in the first main surface for reflecting the light propagating in the light guiding structure towards the second main surface such that the light is emitted through the second main surface.

In an embodiment, the lighting structure comprises a number of light emission structures, the emission structure in particular comprising a reflection recess, wherein a depth of the reflection recess increases with a distance to the light generation assembly.

In an embodiment, a surface of the reflection recess is covered with a reflective material. Thus, the reflective material ensures reflection, while the shape of the recess determines a direction of the reflection towards the second main surface.

In an embodiment, an optical element having substantially the shape of the reflection recess is provided in the reflection recess, thereby at least partly filling the reflection recess. Instead of using a reflective material, an optical element may be provided in the reflection recess for reflection e.g. due to a difference in refractive index between a gas such as air provided in a gap between a surface of the reflection recess and the optical element or e.g. due to a difference in refractive index between the light guiding structure and the optical element.

In an embodiment, the light assembly recess and the light emission structure, such as a reflection recess, may be combined. For example, a part of a surface of the light assembly recess is configured to enable light output by the light generation assembly to enter the light guiding structure, whereas another part of the surface may be configured to reflect incident light towards the second main surface.

In an embodiment, a number of light emission structures is provided. The light emission structures may be non-uniformly distributed over the first main surface. In a particular embodiment, the number of light emission structures per unit area increases with an increasing distance to the light generation assembly. Since the amount of light propagating in the light guiding structure decreases with an increasing distance to the light generation assembly due to the angular spread and due to emission of a part of the light at light emission structures, the number of light emission structures per unit area may be increased in order to emit a substantially same amount of light per unit area.

### BRIEF DESCRIPTION OF THE DRAWINGS

Hereafter, the present invention is elucidated in more detail with reference to the appended drawings illustrating non-limiting embodiments and wherein:

FIG. 1 shows a top view of an embodiment of a lighting structure according to the present invention;

FIG. 2A shows a cross-sectional view of a first embodiment of a light guiding structure and a light emission structure in accordance with the present invention;

FIG. 2B shows a perspective view of a cross-section of the light emission structure of FIG. 2A;

FIG. 3A-3C show a cross-sectional view of a second embodiment of a light guiding structure and a light emission structure in accordance with the present invention;

FIG. 4A shows a perspective view of a part of a first embodiment of a light generation assembly for use in a lighting structure according to the present invention;

FIG. 4B-4C show a perspective view of a part of a second embodiment of a light generation assembly for use in a lighting structure according to the present invention; and

FIG. 5A-5B show a cross-sectional view of a third and fourth embodiment of a light guiding structure and a light emission structure in accordance with the present invention, respectively.

### DETAILED DESCRIPTION OF EXAMPLES

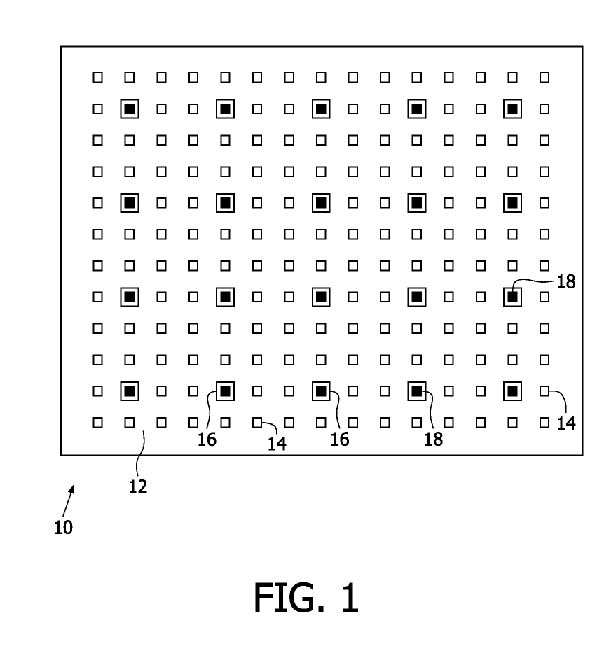

In the drawings, same reference numerals refer to like elements. FIG. 1 shows a top view of a lighting structure 10. The lighting structure 10 comprises a plate-shaped light guiding structure 12. In the light guiding structure 12, a number of light emission structures 14 and a number of light assembly recesses 16 are provided. In each light assembly recess 16, a light generation assembly 18 is arranged.

In operation, a light generation assembly 18 generates light using a light source such as a LED, OLED, or laser diode, for example. The generated light is output in a direction in a plane substantially parallel to a plane of the plate-shaped light guiding structure 12. The generated light is transferred into the light guiding structure 12 and thereafter the light propagates in the light guiding structure 12. Light propagating in the light guiding structure 12 will not leave the light guiding structure 12 due to a relatively small angle between a propagation direction and a surface of the light guiding structure 12 resulting in an internal reflection if the propagating light is incident on said surface.

The light propagating in the light guiding structure 12 may be incident on one of the light emission structures 14. The light emission structure 14 is configured and arranged such that light that is incident on the light emission structure 14 is emitted from the light guiding structure 12. For example, the light emission structure may change a propagation direction of incident light such that the light may pass through an interface between the light guiding structure 12 and the air around the light guiding structure 12.

As illustrated, the light emission structures 14 are uniformly distributed, arranged in a rectangular grid. The distribution of the emission structures 14 may however as well be non-uniform depending on the desired lighting conditions to be generated by the lighting structure 10. As illustrated, the light generation assembly 18 may be square shaped. However, the light generation assembly may take any kind of shape such as round, triangular or any other suitable shape. The same applies to the shape of the light assembly recesses 16 and the light emission recesses 14. The shape of the light generation assemblies 18, the light assembly recesses 16 and the light emission recesses 14 may vary over the light guiding structure 12, if desired, or, as illustrated, the shapes may be the same.

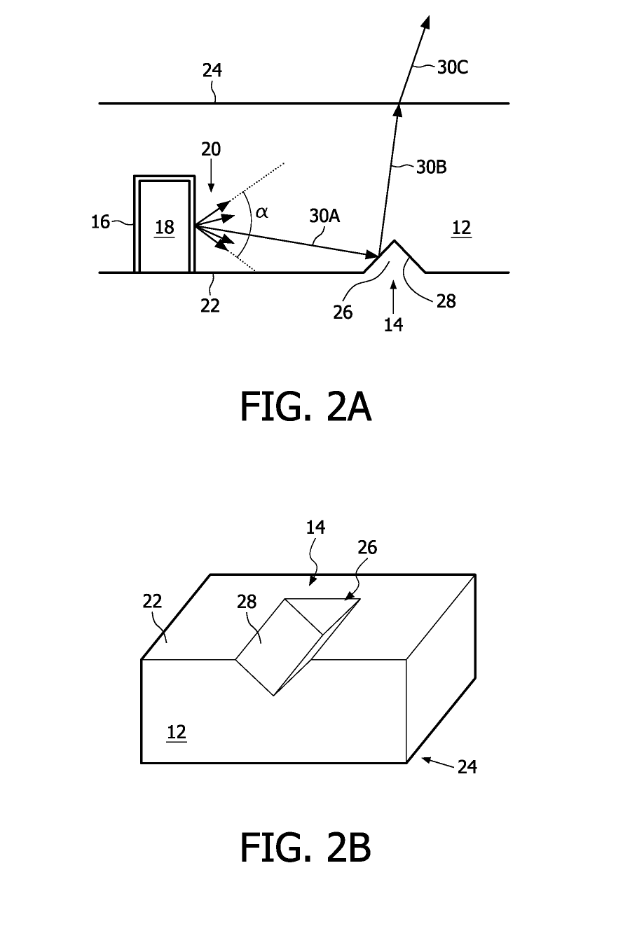

FIG. 2A shows a cross-section of a light guiding structure 12. The light guiding structure 12 is provided with a light assembly recess 16 and a light emission structure 14. In the light assembly recess 16 a light generation assembly 18 is arranged. The light generation assembly 18 generates and outputs light 20 as indicated by the arrows. The light 20 has a predetermined angular spread α, which means that the light 20 is spread and directed in a cone having a top angle α.

The light guiding structure 12 has a first main surface 22 and a second main surface 24. The second main surface 24 is substantially parallel and opposite to the first main surface 22. The light emission recess 14 is arranged in the first main surface 22, whereas, in this embodiment, the light 20 is to be emitted from the second main surface 24.

In the illustrated embodiment, the light emission structure 14 comprises an in cross-section triangularly shaped light emission recess 26. FIG. 2B shows the light emission recess 26 in a perspective view. At an inner surface 28 of the light emission recess 26, a reflective material, such as an aluminum coating, may be arranged.

As described in relation to FIG. 1, in operation, the generated light 20 is transferred from the light generation assembly 18 into the light guiding structure 12. The angular spread a of the light 20 may be selected such that if (a part of) the light 20 is directly incident on one of the main surfaces 22, 24 it is internally reflected. Thus, no light leaves the light guiding structure 12 through one of the main surfaces 22, 24. The light 20 propagates through the light guiding structure 12 until it is incident on the reflective inner surface 28 of the light emission structure 14. The inner surface 28 may be arranged at an angle of about 45° with respect to the first main surface 22. Thus, a light beam 30A incident on the inner surface 28 of the light emission recess 26 is reflected under an angle of about 90° and thus redirected towards the second main surface 24. Moreover, since all light beams are reflected under a same angle, the angular spread of the light 20 is maintained. A reflected light beam 30B is directed towards the second main surface 24 and approaches the second main surface 24 substantially perpendicularly. Therefore, the reflected light beam 30B may pass the interface between the light guiding structure 12 and the air, thus being emitted from the light guiding structure 12 as an output light beam 30C.

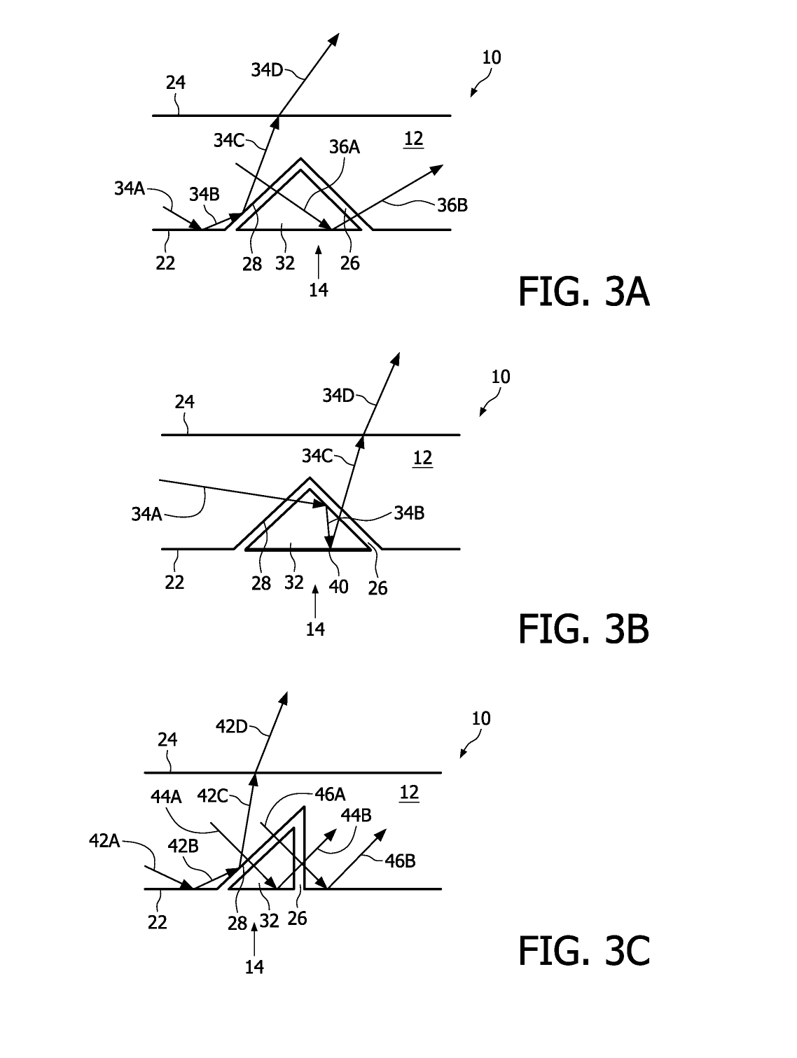

FIGS. 3A and 3B show an embodiment in which an optical element 32 is arranged in the light emission recess 26 of the light emission structure 14. Instead of using a reflective coating, reflection at an interface between two media having different refractive indices is used. In FIG. 3A, for example, an incident light beam 34A is internally reflected due to a refractive index difference at the first main surface 22 of the light guiding structure 12. The reflected light beam 34B is again reflected at the inner surface 28 of the emission recess 26 and the reflected beam 34C propagates to the second main surface 24. At the second main surface 24, the reflected beam 34C is bend slightly away from a line perpendicular to the second main surface 24 (the normal) resulting in the output light beam 34D. Another incident light beam 36A, however, passes through the inner surface 28 of the light emission recess 26 and enters the optical element 32. In the optical element 32, the light beam 36A is internally reflected at the first main surface 22 and redirected. The reflected light beam 36B passes the inner surface 28 of the light emission recess 26 and enters the light guiding structure 12 again. At the second main surface 24, the reflected light beam 36B will again be reflected and so on, until the light beam is incident on a light emission recess 26 at such an angle that the light beam is directed towards the second main surface 24 and approaches the second main surface 24 at a suitable angle to pass the interface.

In FIG. 3B it is shown that an incident light beam 34A may enter the optical element 32 and be reflected internally towards the first main surface 22. The reflected light beam 34B may approach the first main surface 22 such that it may pass the interface and leave the light guiding structure 12 and the optical element 32 at the first main surface 22. If it is not desired that light leaves the lighting structure 10 at the first main surface 22, a reflective material 40 such as an aluminum coating may therefore be provided at the first main surface 22 of the optical element 32. Due to the presence of the reflective material 40, the reflected light beam 34B is reflected again and a reflected light beam 34C is directed towards the second main surface 24 and after passing the second main surface 24 it becomes an output light beam 34D.

FIG. 3C shows a similar embodiment as shown in FIGS. 3A and 3B, however, no light beam will be able to leave the lighting structure 10 at the first main surface 22, even without the presence of a reflective material, as illustrated by three possible light beam trajectories 42A-42D, 44A-44B and 46A-46B.

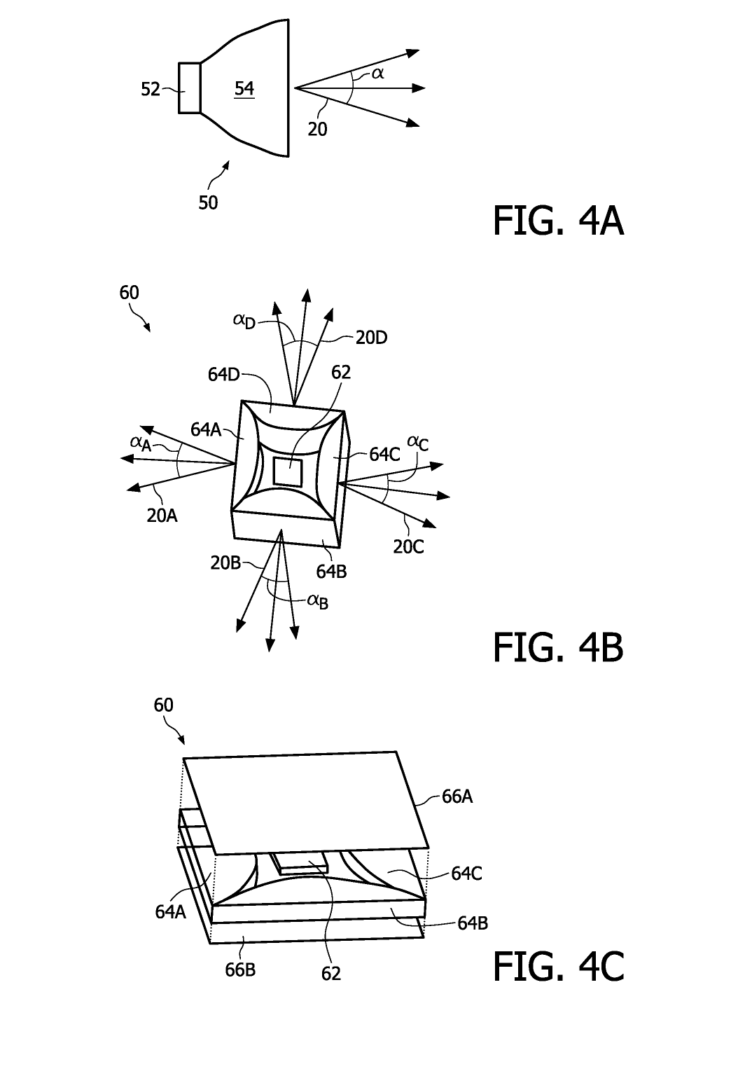

FIG. 4A shows a part 50 of an embodiment of a light generation assembly. Said part 50 of the light generation assembly comprises a light source 52 such as a LED or any other suitable light source such as an incandescent lamp, a fluorescent lamp or a gas discharge lamp. Light generated by the light source 52 enters a collimator 54, e.g. a compound parabolic collimator (CPC) as known in the art. Light 20 output by the collimator 54 has a predetermined angular spread (i.e. angular distribution) having an angle α, which means that the light 20 is emitted in a cone shaped distribution, wherein the cone has a top angle α. The light generation assembly comprising the part 50 may emit light 20 at one side of the assembly. If multiple collimators 54, possibly supplemented by multiple light sources 52, are used, the light generation assembly may as well output light at a number of sides.

FIGS. 4B and 4C show an embodiment of (a part of) a light generation assembly 60 configured for emitting light at four sides. In the illustrated embodiment, a top emitting LED 62 is used as a light source. The LED 62 is surrounded at four sides by four optical elements 64A, 64B, 64C and 64D. Light generated by the top-emitting LED 62 is reflected by mirrors 66A, 66B arranged above and below, respectively, the LED 62 and the optical elements 64A-64D. It is noted that the perspective view of FIG. 4C is an exploded perspective view in which the mirrors 66A, 66B are lifted from the optical elements 64A-64D, but in practice, the mirrors 66A, 66B are arranged on the optical elements 64A-64D. The optical elements 64A-64D are configured to output light from the LED 62 with a predetermined light distribution α_{A}-α_{D}, respectively. The angular spread α_{A}-α_{D} of each optical element 64A-64D may be substantially equal or the respective angular spreads α_{A}-α_{D} may differ, if so desired.

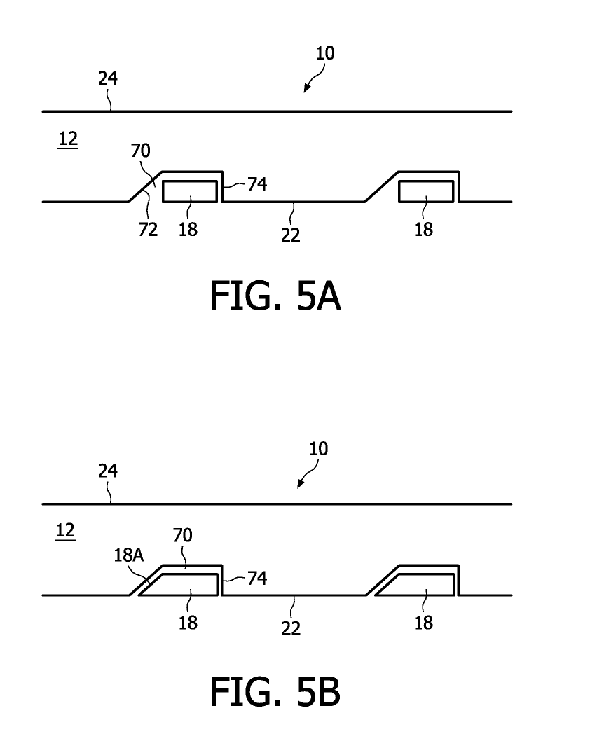

FIG. 5A shows an embodiment of a lighting structure 10, in which a light assembly recess and a light emission structure are combined to a single recess 70 having a slanted reflective inner surface 72 for reflecting internally propagating light towards the second main surface 24. A light generation assembly 18 is arranged in the same recess 70 and may emit light into the light guiding structure 12 at another inner surface 74 of the recess 70. As shown in FIG. 5B, an outer shape of the light generation assembly 18 may be configured in accordance with a shape of the recess 70. Instead of the inner surface 72 being reflective, the slanted outer surface 18A of the light generation assembly 18 may be reflective, e.g. be coated with a reflective material. In such an embodiment the efficiency may be slightly higher compared to the embodiment of FIG. 5A, since a part of the light may now be reflected by internal reflection, which ahs a higher efficiency compared to reflection by a reflective surface.

In any of the illustrated embodiments, and of course also in not illustrated embodiments, a dynamic optical element such as a PDLC diffuser, as known in the relevant art, may be used to control the angular distribution of the light output by the light generation assembly. Thus, the output light distribution of the lighting structure may be controlled, since the light distribution of the output light is in any of the above-described embodiments substantially the same as the light distribution output by the light generation assembly. The internal reflections and the reflections by reflective surfaces do not substantially alter the angular distribution of the light.

The lighting structure, in particular the light generation assembly may be provided with heat transfer means or heat spreading means. Such heat transfer means may be combined with the reflective material or coating. In an embodiment, heat control means such as a cooling fan may be provided.

Driving circuitry for operating the light source, in particular if a LED is used, may be provided in the light generation assembly or may be provided outside the light guiding structure.

The lighting structure according to the present invention is suitable for outputting light having a controllable color. For example, a light generation assembly may comprise a number of LED's each having a different color. In another embodiment, each light generation assembly has a LED with a single but varying color and the different light colors are mixed in the light guiding structure. In yet another embodiment, in particular having a light generation assembly emitting light in different directions, as e.g. illustrated in FIG. 4B-4C, a different color is emitted in each different direction. The desired color is then mixed in the light guiding structure.

A feedback driving circuit may be used to control the light output of the lighting structure. In particular, color point correction may be applied to correct for lifetime effects. For example, the brightness of the light output is dependent on the lifetime of an LED and its temperature. By measuring the light output, the brightness may be controlled in order to obtain a desired brightness.

Although detailed embodiments of the present invention are disclosed herein, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Further, the terms and phrases used herein are not intended to be limiting; but rather, to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term coupled, as used herein, is defined as connected, although not necessarily directly, and not necessarily by means of wires.

1. Lighting structure comprising:
a light generation assembly comprising a light source for generating light; and
a substantially plate-shaped light guiding structure, the light guiding structure defining a light assembly recess and comprising a light emission structure,
wherein the light generation assembly is arranged in the light assembly recess of the light guiding structure such that light emitted by the light generation assembly propagates into the light guiding structure,
wherein the light emission structure is arranged for emitting light from the light guiding structure,
wherein the light guiding structure comprises a first main surface and a second main surface being opposite to the first main surface and wherein the light emission structure comprises a reflection recess in the first main surface for reflecting the light propagating in the light guiding structure towards the second main surface such that the light is emitted through the second main surface, and
wherein the light assembly recess and the light emission structure form a single recess.

2. Lighting structure according to claim 1, wherein the light source is a LED.

3. Lighting structure according to claim 1, wherein the light generation assembly is configured for generating a light beam having a predetermined angular spread.

4. Lighting structure according to claim 3, wherein the light generation assembly comprises a collimator for generating the light beam from light emitted by the light source.

5. Lighting structure according to claim 3, wherein the light generation assembly comprises a controllable optical element for controlling the light beam, the controllable optical element comprising a PDLC diffuser for electrically adjusting the angular spread.

6. Lighting structure according to claim 3, wherein the light emission structure is configured for emitting the light from the light guiding structure such that the angular spread of the light beam generated by the light generation assembly remains substantially unaltered.

7. (canceled)

8. Lighting structure according to claim 1, wherein the lighting structure comprises a number of light emission structures and wherein a depth of the reflection recess increases with a distance to the light generation assembly.

9. Lighting structure according to claim 1, wherein a surface of the reflection recess is covered with a reflective material.

10. Lighting structure according to claim 1, wherein an optical element having substantially the shape of the reflection recess is provided in the reflection recess, thereby at least partly filling the reflection recess.

11. Lighting structure according to claim 10, wherein a gap is provided between a surface of the reflection recess and a surface of the optical element.

12. Lighting structure according to claim 10, wherein the optical element has a first refractive index and wherein the light guiding structure has a second refractive index, the first refractive index and the second refractive index being different such that light propagating through the light guiding structure and being incident on an interface between a surface of the reflection recess and the optical element is reflected towards the second main surface.

13. (canceled)

14. Lighting structure according to claim 1, wherein the light guiding structure comprises a first main surface and a second main surface being opposite to the first main surface and wherein the lighting structure comprises a number of light emission structures and wherein the number of light emission structures are non-uniformly distributed over the first main surface such that the number of light emission structures per unit area increases with a distance to the light generation assembly.

15. Lighting structure according to claim 1, wherein said single recess is provided with a slanted reflective inner surface for reflecting internally propagating light towards the second main surface.

16. Lighting structure according to claim 1, wherein the light generation assembly is configured in accordance with a shape of said single recess.

17. Lighting structure according to claim 1, wherein the light generation assembly comprises a slanted reflective outer surface.
